(19) United States
(12) Patent Application Publication
(10) Pub. No.: US 2002/0172921 A1
(43) Pub. Date: Nov. 21, 2002

(54) Fiber tipped dental substance applicator

(76) Inventor: Steven Jensen, South Jordan, UT (US)

Correspondence Address: Daniel P. McCarthy, PARSONS, BEHLE & LATIMER, 201 South Main Street, Suite 1800, P.O. Box 45898, Salt Lake City, UT, 84145-0898, US

(21) Appl. No.: 10/150,437

(22) Filed: May 16, 2002

Related U.S. Application Data
(63) Continuation-in-part of application No. 09/858,052, filed on May 15, 2001, now Pat. No. 6,390,817.

(51) Int. Cl. A61C 5/04

(52) U.S. Cl. 433/89; 433/80

(57) ABSTRACT

A fiber tipped dental substance applicator is disclosed. The applicator may include a fluid passageways through which a dental substance may flow fibers at the end of the applicator. The tip may include a flocked smoothing bulb.

### CLAIM FOR PRIORITY

This is a continuation-in-part of U.S. patent application Ser. No. 09/858,052 filed on May 15, 2001, now U.S. Pat. No. ______, and priority is claimed thereto.

### BACKGROUND

The invention relates to applicators for applying dental substances to dental surfaces such as teeth.

### BACKGROUND ART

In the prior art, there were various dental substance applicators with flocked tips. Those prior art devices suffered from several disadvantages.

### BRIEF SUMMARY OF THE INVENTION

In some embodiments of the invention, a fiber tipped dental substance applicator is provided that closely juxtaposes fibers with dental substances being dispensed so that dental substance may be dispensed and spread on a dental surface in an efficient fluid motion to achieve a desired aesthetic and functional result, including a good seal.

Other objects, features and advantages of the invention will become apparent upon reading the specification and reviewing the appended drawings.

### BRIEF DESCRIPTION OF THE DRAWINGS

FIG. 1 depicts a syringe dispenser and a fiber tipped dental substance applicator of the invention in use on a dental surface.

FIG. 2 depicts a cross sectional view of a syringe and fiber tipped dental substance applicator.

FIGS. 3a, 3b and 4 depict a side view, a perspective view and a front view of an applicator tip of the invention.

FIG. 5 depicts a cross sectional view of the applicator tip of FIGS. 3a, 3b and 4 at 5-5.

FIG. 6 depicts a distal end view of the applicator tip.

FIG. 7 depicts a side view of an alternative applicator tip of the invention.

FIG. 8 depicts a cross sectional view at 8-8 from FIG. 7 of the applicator tip.

FIG. 9a depicts another embodiment of a fiber tipped dental substance applicator.

FIG. 9b depicts a close-up view of the tip 905 of FIG. 9a.

FIG. 9c depicts a side view of the applicator of FIG. 9a.

FIG. 9d depicts a cross sectional view of the tip of the applicator of FIG. 9a.

FIG. 10 depicts another fiber tipped dental applicator.

### DETAILED DESCRIPTION

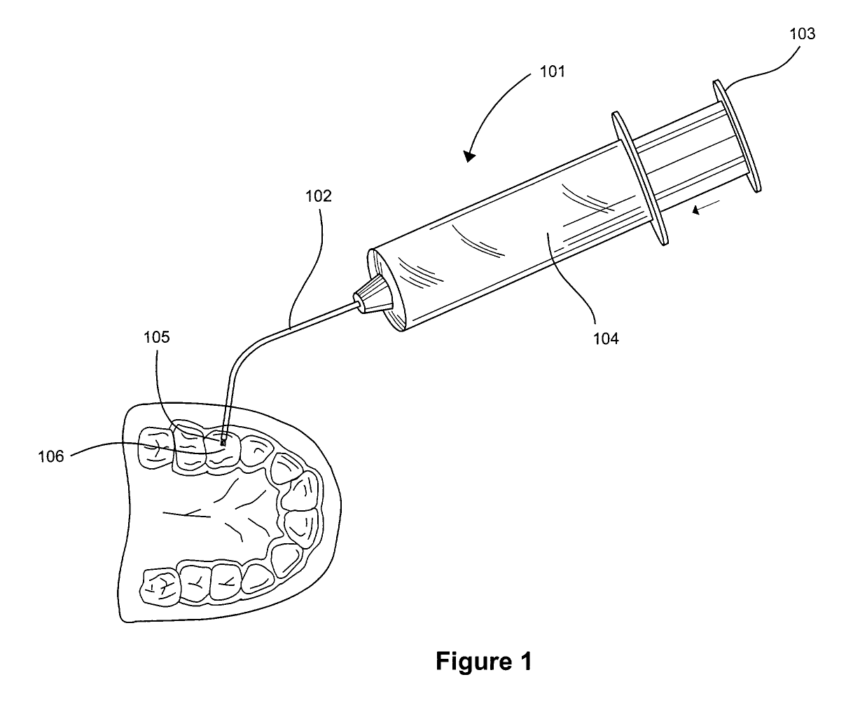

Referring to FIG. 1, a single barrel syringe 101 is depicted with a fiber tipped dental substance applicator 102 installed thereon. The syringe has a reservoir 104 for holding a dental substance and a plunger 103 for exerting pressure on the dental substance in order to cause the dental substance to be forced through the applicator 102. The applicator 102 is fiber tipped 105 for spreading a dental substance on a dental surface 106 after the dental substance has been forced from reservoir through the applicator 102.

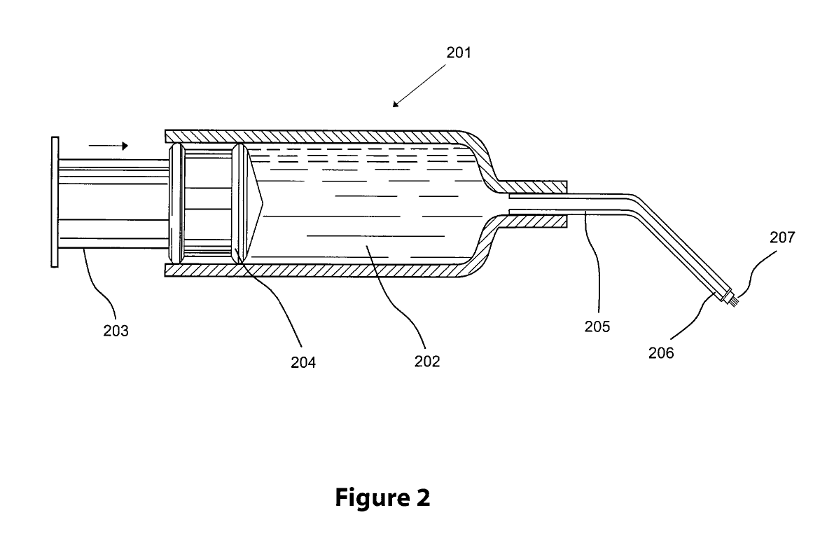

Referring to FIG. 2, a cross sectional view of a syringe 201 with applicator 207 of the invention is depicted. The syringe 201 includes a reservoir or chamber 202 for holding a dental substance to be dispensed. A plunger 203 is provided with seal 204 within the barrel for forcing dental substance from the reservoir 202. The dental substance travels from the reservoir through the delivery passageway 205 to delivery orifice 206. The delivery passageway 205 is preferably a metal cylinder that may be angled for desired presentation within a patient's mouth. Because the delivery passageway 205 is cylindrical, it is approximately the same dimension along its length rather than being of larger dimension at the syringe end than at the orifice. This makes it easier for the dental care provider to place it in proximity with various dental structures, hence making it more convenient to use than some prior art devices. The fiber tipped dental substance applicator 207 is held in place in the orifice 206 of the delivery passageway 205. The fiber tipped dental substance applicator has the fibers generally in its center, which will be aligned with the center of the bore of the orifice 206, and will have a plurality of recesses in it to permit dental substance to flow along the sides of the fibers. Centering the fibers along the bore is advantageous in that it makes movement of the fibers intuitive as they are used to apply a dental substance to a dental surface.

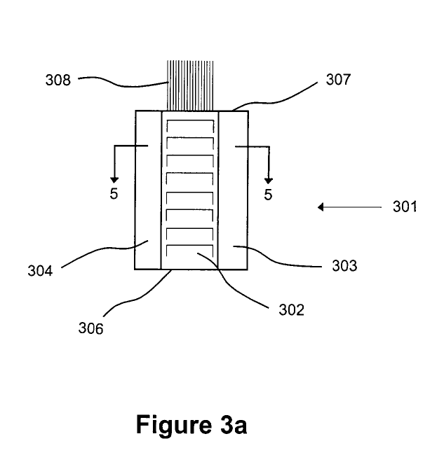

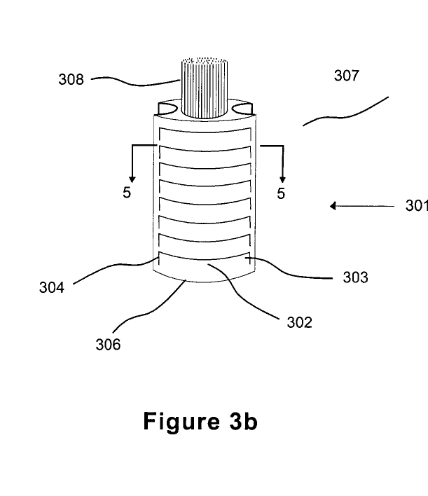

FIGS. 3a and 3b depict front and side views of a fiber tipped dental substance applicator 301 of the invention. It includes a body 302 which is generally cylindrical in shape or otherwise shaped to match the shape of the interior of the bore of the orifice 206 such as the interior of a cylindrical metal bore. The applicator 301 includes at least one pathway 303 and 304 (shown in phantom) along the outer periphery of the body 302 through which a dental substance may flow when forced from the orifice 206. It has a proximal end 306 for insertion into the bore and a distal end 307. On the distal end 307 a plurality of fibers 308 are found for applying the dental substance to a dental surface. The fibers 308 are preferably located so that they will be about in the center of the bore of the orifice 206.

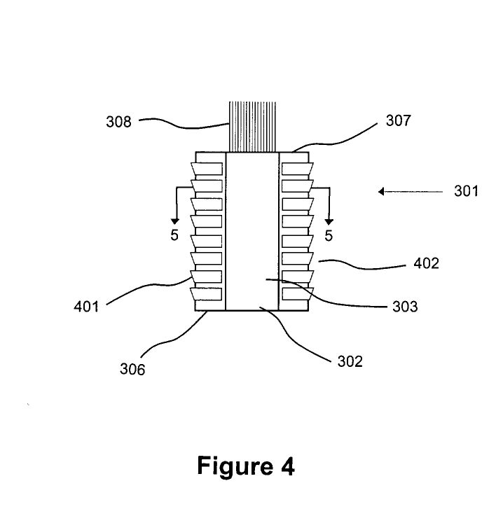

FIG. 4 depicts a side view of the fiber tipped dental substance applicator 301. From this view, only one fluid flow pathway 303 or passage is visible. Also depicted in this view are one-way locking lips or plates 401 and 402 located on the exterior periphery of the body 302. The lips 401 and 402 would preferably be plastic or other flexible material and would bend out of the way as the applicator 301 is pressed into the bore. Once in the bore, however, the lips 401 and 402 serve to frictionally resist removal of the applicator 301 from the bore to avoid inadvertent detachment in a patient's mouth. Alternatively, a textured surface of the body 302 or other mechanical locking device could be used to fasten the applicator 302 in the bore.

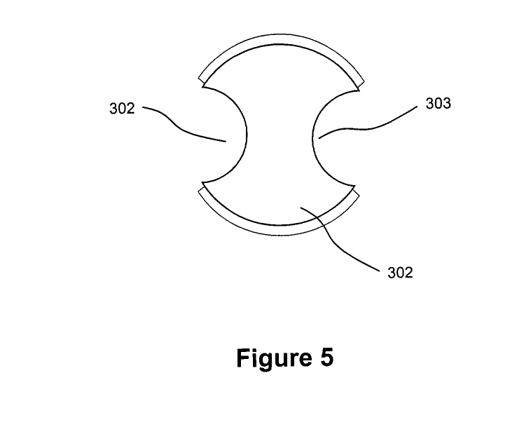

FIG. 5 is a cross sectional view of the fiber tipped dental substance applicator 301 at 5-5. It depicts the body 302 and the pathways 303 and 304.

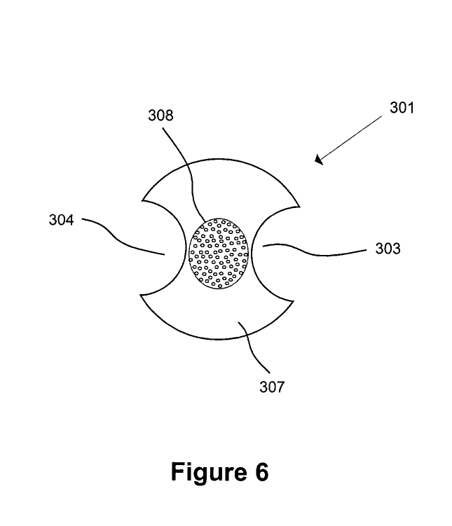

FIG. 6 depicts an end view of the fiber tipped dental substance applicator 301 from the distal end 307. The fibers 308 are shown adjacent the pathways 303 and 304.

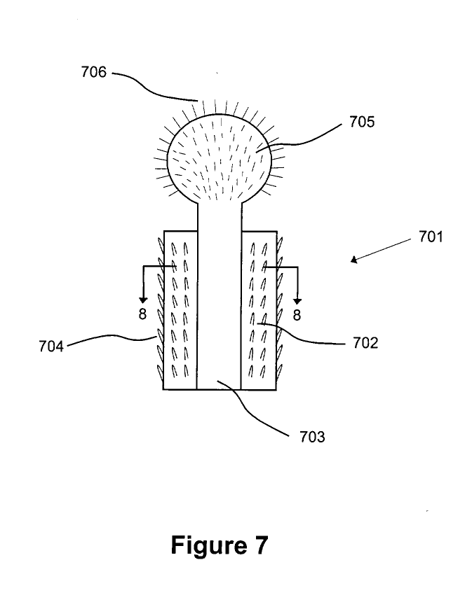

FIG. 7 depicts a side view of an alternative applicator tip 701 of the invention. The applicator tip 701 includes a body 702 with fluid flow grooves 703 with hooks 704 for frictional engagement with a metal cylindrical orifice of a syringe. The tip 701 includes a flocked distal smoothing bulb 706 having individual flocking fibers 705 thereon for smoothing or applying a dental substance.

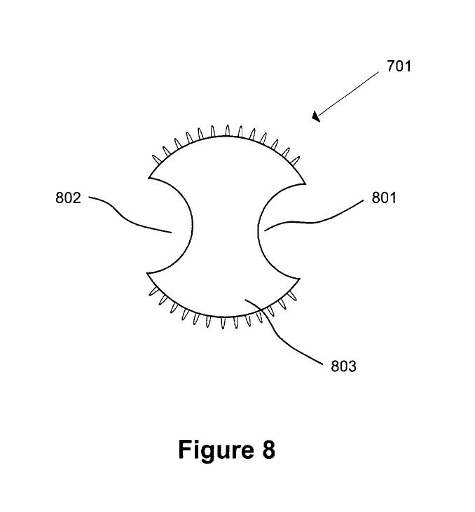

FIG. 8 depicts a cross sectional view at 8-8 from FIG. 7 of the applicator tip 701. The tip 701 includes a body 803 such as injection molded plastic with a plurality of fluid flow passages 801 and 802 through which a dental substance may flow to the smoothing bulb 706.

By providing one or more passageways adjacent the fibers or smoothing bulb, the invention permits central location of the fibers with the dental substance flowing right next to them. Clogging of the fibers by a filled material is avoided, the expense and complexity of a helical passageway is avoided, and symmetry of the passageways with respect to the fibers is maintained. As desired, there may be as many pathways as desired, preferably two or more.

The bristles may be of a length, rigidity, density and number that will achieve the desired stiffness and precision in applying a substance to a dental surface, depending on the application.

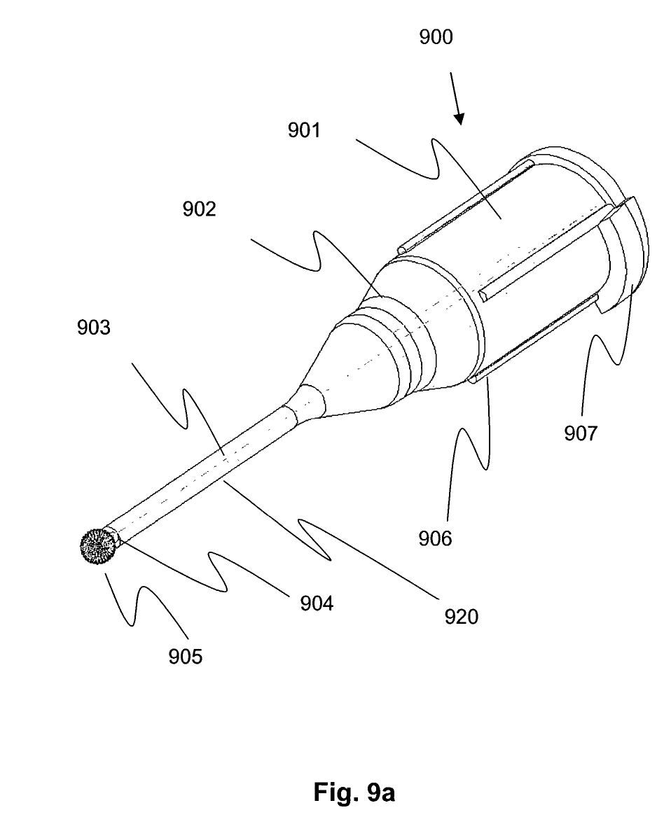

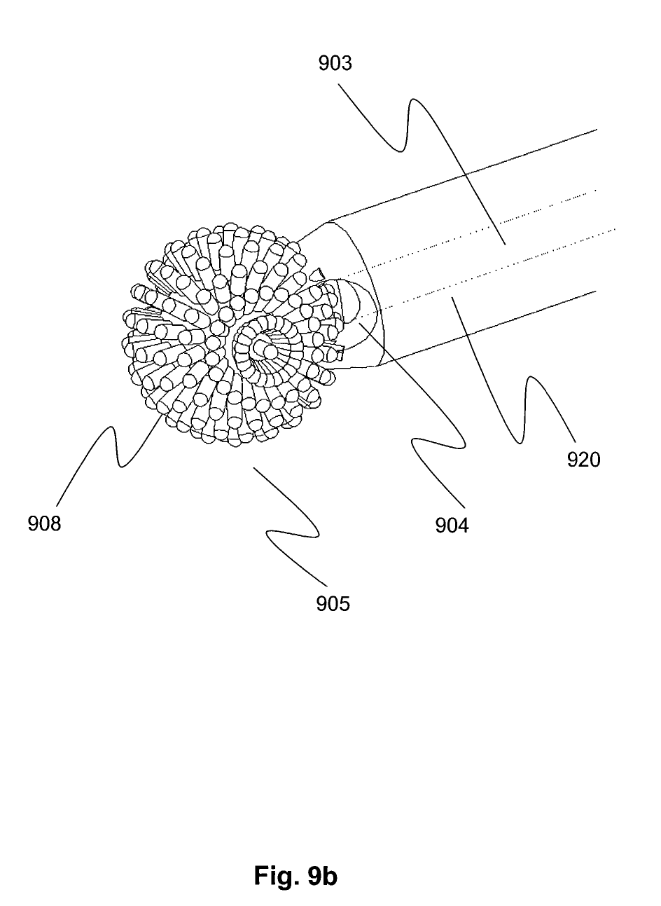

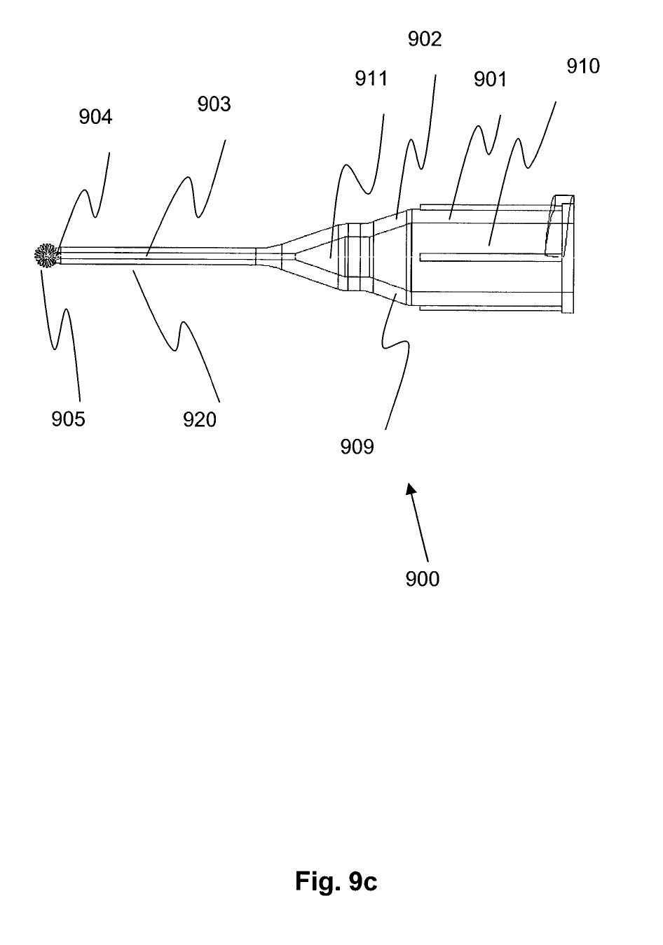

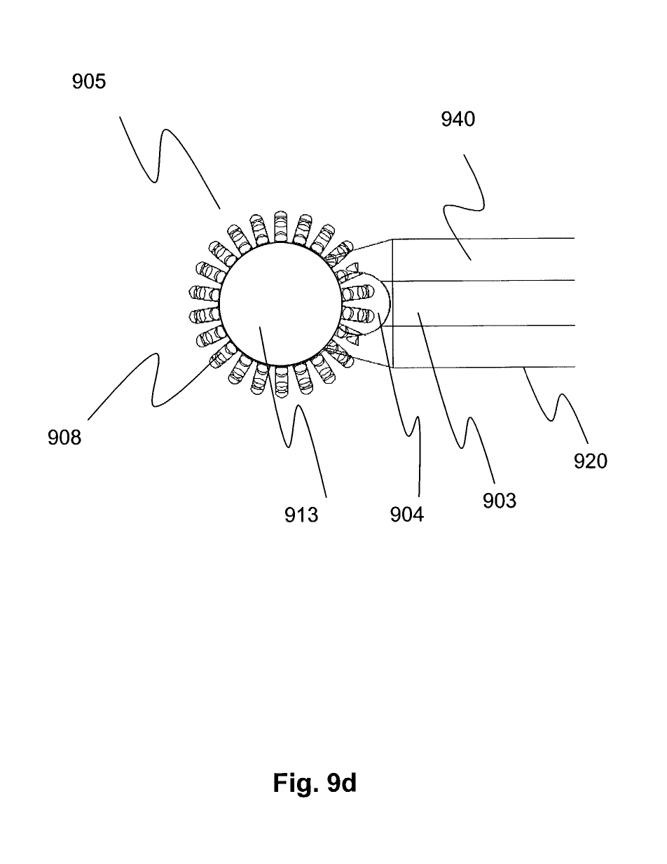

Referring to FIG. 9a another embodiment of a fiber tipped dental substance applicator 900 is depicted. The applicator 900 includes a body portion 901 for mounting to a standard dental syringe. Mounting is achieved by a mechanical grip such as luer-lock structure 907. Strengthening ribs 906 are located on the body 901. A tapered region 902 is provided distal to the body 901, tapering down to an elongate projector 920. A bore 903 is provided through the projector 920 and extending through the tapered region 902 and body 901. At the distal end of the projector 920, at least one exit orifice 904 is provided adjacent an applicator tip 905 so that a dental substance may be caused to move down the bore 903 to the distal end of the dental substance applicator where it exits the exit orifice 904 adjacent the applicator tip 905. The applicator tip 905 has fibers or flexible arms located thereon for applying the dental substance to a dental surface.

FIG. 9b depicts a close-up view of the applicator tip 905 of FIG. 9a. There may be more than one exit orifice 904 to permit a dental substance to exit the tip on more than one side of the tip 905. The tip 905 may have fibers or flexible arms 908 located thereon for applying the dental substance to a dental surface. The fibers could be flocking, such as flocking known in the dental industry. Or the flexible arms could be plastic arms molded integrally with the dental substance applicator 900 or molded separately. Or the fibers could be any other flexible projections useful for applying a dental substance that exits the exit orifice 904. As depicted, the fibers 908 radiate from a generally central point to form a generally spherical periphery, but other orientations and shapes may be chosen depending on the particular application.

FIG. 9c depicts a cross sectional side view of the applicator of FIG. 9a. The longitudinal bore 903 of the projector is visible. The body 901 has an interior cavity 910 for receiving a dental substance from a syringe. The dental substance would then be forced into a conical staging cavity 911 of the tapered region 902 from where it would travel into the bore 901, and out the exit orifice to the applicator tip 905. The dental substance would be moved from the proximal to distal end of each component by a hydraulic force generated by actuating a plunger of a dental syringe. Note that the applicator 900 has a wall 909 of appropriate material and thickness to provide strength to withstand handling by a dentist and hydraulic forces during use.

FIG. 9d depicts a cross sectional view of the applicator tip 905 of FIG. 9a at the distal end of projector 920. The bore 903 of projector 920 for transporting a dental substance to the tip 905 is depicted. The projector 920 has a wall 940 of appropriate material and thickness to provide strength to withstand handling by a dentist and hydraulic forces during use. That wall 940 defines the bore 903. An exit orifice 904 is shown. The applicator tip 905 is shown as having a smoothing bulb 913 from which project fibers or flexible arms 908. The heart 913 could be of any shape, or could be omitted. The fibers or flexible arms 908 are shown as having rounded distal ends but could be of other shapes. The fibers or flexible arms 908 should be of appropriate length, diameter, rigidity and flexibility to apply a dental substance to a dental surface.

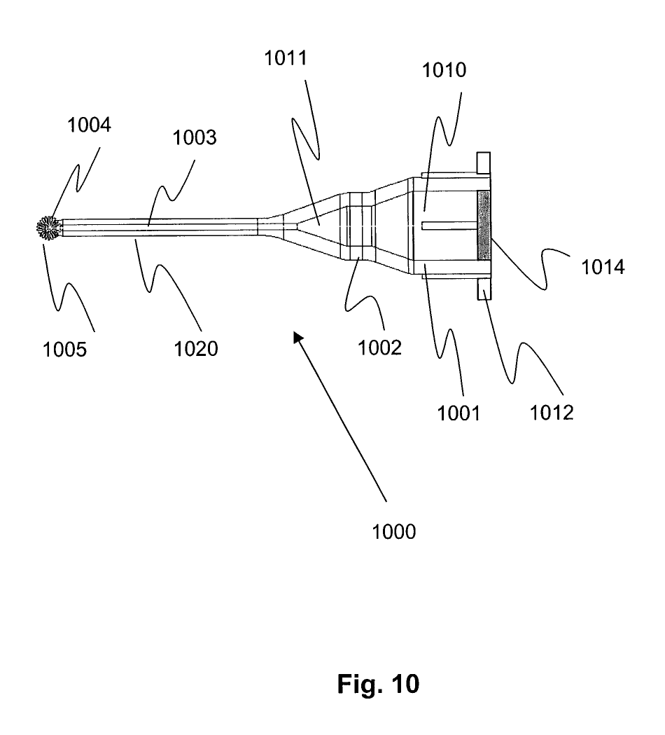

FIG. 10 depicts another fiber tipped dental substance applicator 1000. This applicator 1000 is configured for disposable unit dose uses. A body 1001 is provided that has handles 1012 for gripping by a dentist. A reservoir 1010 is provided in the body 1001 for holding a dental substance until the dentist is ready to dispense it. A plunger 1014 or other means for expelling the dental substance 1014 is provided. A tapered region 1002 is provided with a staging area 1011 for holding dental substance and directed it into the projector 1020 through the bore 1003 out the exit orifice adjacent the fiber tip 1005 where fibers or flexible arms 1004 are found. The fibers or flexible arms 1004 may be used to apply and smooth the dental substance on a dental surface.

It can be seen from these figures that the applicator may be configured so that an applicator tip is located coincident with the longitudinal axis of a bore through which a dental substance travels to exit the applicator. One or more exit orifices may be provided at distal end of such bore and adjacent the applicator tip. If desired, the exit orifices may be radially located about the longitudinal axis of the bore. For example, two (2) exit orifices could be located 180 degrees apart on each side of the applicator tip. Thus, the fibers or flexible arms used to apply dental substance flowing from the exit orifice(s) would be in a position to work with dental substance that exits the bore exit orifice(s). In such configuration, the fibers and smoothing bulb are thus in line with the flow of the dental substance and force the dental substance flow to deviate from the longitudinal axis of the bore.

The applicator may be constructed in several ways. First, it may be injection molded as a single integral unit from a single material with all components, including the fibers or flexible arms, being integral or contiguous to the whole. Second, it can be injection molded as separate components that are later assembled, such as by welding, epoxy or adhesive. The second construction may be an advantage if it is desired to use one hardness of plastic for some portions of the device, and another hardness of plastic for other portions of the device. For example, it may be desired to use softer more flexible plastic for the fibers than for the luer lock. A third construction would use injection molding to prepare the entire applicator as a unitary device except for the fiber. The fiber would then be separately attached to the tip, such as on the smoothing bulb, by any desired method such as plastic welding, adhesive, epoxy, flocking or otherwise. Other ways of manufacturing the applicator are possible as well.

While the present invention has been described and illustrated in conjunction with a number of specific embodiments, those skilled in the art will appreciate that variations and modifications may be made without departing from the principles of the inventions as herein illustrated, described and claimed.

The present invention may be embodied in other specific forms without departing from their spirit or characteristics. The described embodiments are to be considered in all respects as only illustrative, and not restrictive. The scope of the invention is, therefore, indicated by the appended claims, rather than the foregoing description. All changes that come within the meaning and range of equivalency of the claims are to be embraced within their scope.

1. A fiber tipped dental substance applicator comprising:
a body,
a cavity within said body for receiving a dental substance from a dental substance dispenser,
a tapered region at the distal end of said body,
a staging area within said tapered region for receiving a dental substance from said body,
a projector emanating from the distal end of said tapered region,
a bore within said projector which permits a dental substance to move from said staging area to said bore distal end under hydraulic pressure,
at least one exit orifice at the distal end of said projector, said exit orifice serving to permit a dental substance to exit said bore,
an applicator tip located at said projector distal end and adjacent said bore,
a smoothing bulb that is part of said applicator tip,
a plurality of fibers located on said smoothing bulb and emanating generally radially therefrom to form a generally spherical exterior geometry;
said fibers being configured for applying a dental substance that exits said exit orifice to a dental surface.

2. A device as recited in claim 1 further comprising a mechanical attachment for attaching the applicator to a dental syringe.

3. A device as recited in claim 1 further comprising a luer-lock for attaching the applicator to a dental syringe.

4. A device as recited in claim 1 further comprising a plurality of exit orifices.

5. A device as recited in claim 1 wherein said fibers are flocked on said smoothing bulb.

6. A device as recited in claim 1 wherein said fibers are integral and contiguous with the applicator.

7. A device as recited in claim 1 wherein the dental substance applicator is of unitary construction with each structure thereof, including the fibers, being integral and contiguous with the whole.

8. A fiber tipped dental substance applicator comprising:
a body for attachment to a dental substance dispenser and for receiving a quantity of a dental substance therefrom,
a projector emanating from said body,
a bore within said projector which permits a dental substance to move from said body to the distal end of said bore under hydraulic pressure,
at least one exit orifice at the distal end of said projector, said exit orifice serving to permit a dental substance to exit said bore,
an applicator tip located at the distal end of said projector and permitting a dental substance to exit said bore,
a smoothing bulb that is part of said applicator tip,
a plurality of flexible arms located on said smoothing bulb and emanating therefrom;
said flexible arms being configured for applying a dental substance that exits said exit orifice to a dental surface.

9. A device as recited in claim 8 further comprising a mechanical attachment for attaching the applicator to a dental substance dispenser.

10. A device as recited in claim 8 further comprising a luer-lock for attaching the applicator to a dental substance dispenser.

11. A device as recited in claim 8 further comprising a plurality of exit orifices.

12. A device as recited in claim 8 wherein said flexible arms are flocked on said smoothing bulb.

13. A device as recited in claim 8 wherein said flexible arms are integral and contiguous with the applicator.

14. A device as recited in claim 8 wherein the dental substance applicator is of unitary construction with each structure thereof, including the flexible arms, being integral and contiguous with the whole.

15. A fiber tipped dental substance applicator comprising:
a body for attachment to a dental substance dispenser and for receiving a quantity of a dental substance therefrom,
a projector emanating from said body,
a bore within said projector which permits a dental substance to move from said body to the distal end of said bore under hydraulic pressure,
at least one exit orifice at the distal end of said projector, said exit orifice serving to permit a dental substance to exit said bore,
an applicator tip located at the distal end of said projector and permitting a dental substance to exit said bore,
a plurality of flexible arms on said applicator tip;
said flexible arms being configured for applying a dental substance that exits said exit orifice to a dental surface.

16. A device as recited in claim 15 further comprising a mechanical attachment for attaching the applicator to a dental substance dispenser.

17. A device as recited in claim 15 further comprising a luer-lock for attaching the applicator to a dental substance dispenser.

18. A device as recited in claim 15 further comprising a plurality of exit orifices.

19. A device as recited in claim 15 wherein said flexible arms are integrally molded with said applicator.

20. A device as recited in claim 15 wherein said flexible arms are integral and contiguous with the applicator.

21. A device as recited in claim 15 wherein the dental substance applicator is of unitary construction with each structure thereof, including the flexible arms, being integral and contiguous with the whole.

22. A device as recited in claim 15 wherein said flexible arms are separately attached to the applicator.

23. A device as recited in claim 15 wherein said flexible arms are flocked to the applicator.

24. A device for applying a dental substance to a dental surface comprising:
a body,
a reservoir within said body for storing a dental substance for later use,
means for gripping said body,
means for expelling dental substance from said reservoir,
an exit orifice through which dental substance may exit,
an applicator tip adjacent said exit orifice,
a plurality of fibers located on said applicator tip, said fibers being constructed as an integral and contiguous component with said body and said applicator tip and being made from the same material as said body and said applicator tip,
said fibers being adapted for applying a dental substance to a dental surface.

25. A device as recited in claim 24 further comprising a smoothing bulb from which said fibers emanate, said smoothing bulb being located adjacent said exit orifice.

26. A fiber tipped dental substance applicator comprising:
a body,
a reservoir located within said body for containing a dental substance,
a projector having a proximal and a distal end, said projector emanating from said body at said projector proximal end,
a bore located within said projector, said bore serving to receive dental substance from said reservoir,
a longitudinal axis of said bore,
a plurality of exit orifices located at projector distal end and serving to permit a dental substance to exit said bore,
an applicator tip located at said projector distal end and adjacent said exit orifices,
said applicator tip being situated coincident with said bore longitudinal axis so that said applicator tip in located in the path of dental substance flowing down said bore,
a plurality of fibers located on said applicator tip, said fibers being configured to be useful in applying and spreading dental substance on a dental surface.

27. A device as recited in claim 26 wherein said body, said projector and said fibers are formed as an integral and contiguous unit from the same material.

28. A device as recited in claim 26 wherein said fibers are flocked to said applicator tip.

29. A device as recited in claim 26 further comprising a smoothing bulb as part of said applicator tip, said smoothing bulb being useful in applying dental substance to a dental surface, and said fibers emanating from said smoothing bulb.

30. A device as recited in claim 26 wherein said exit orifices are located radially about said bore at said projector distal end.

31. A device as recited in claim 26 wherein dental substance traveling down said bore must deviate from said bore longitudinal axis in order to move past said applicator tip.

32. A fiber tipped dental substance applicator comprising:
means for containing a dental substance,
at least one exit orifice for permitting dental substance to exit said containing means,
an applicator tip located adjacent said exit orifice and substantially in line with said exit orifice so that dental substance that exits said exit orifice will at least in part contact said applicator tip,
a plurality of fibers located on said applicator tip, said fibers being configured to be useful in applying and spreading dental substance on a dental surface,
said fibers being integrally formed with said applicator tip as a contiguous unit.

33. A method for applying a dental substance to a dental surface comprising the steps of:
obtaining a device for delivering and applying a dental substance to a dental surface that includes:
a reservoir for holding a dental substance for later use by a dental practitioner,
an orifice through which a dental substance may exit said reservoir,
a fiber tipped dental substance applicator, said applicator being installable at said orifice, said applicator including
a body,
a projector having a proximal and a distal end, said projector proximal end being adjacent said body,
a bore in said projector for permitting a dental substance to move within it,
an exit orifice located at said projector distal end serving to permit a dental substance to exit said bore,
an applicator tip located at said projector distal end,
a plurality of fibers located on said applicator tip, said applicator tip and fibers being configured to be useful in applying a dental substance to a dental surface;
forcing a dental substance from said reservoir, through said orifice, through said bore of said projector, and through said exit orifice, and
using said fibers to apply said dental substance to a dental surface.

34. A method as recited in claim 33 wherein said flexible arms are integral and contiguous with the said projector and said body.

35. A method for applying a dental substance to a dental surface comprising the steps of:
obtaining a device for delivering and applying a dental substance to a dental surface that includes:
a reservoir for holding a dental substance for later use by a dental practitioner,
an orifice for permitting a dental substance to exit said reservoir,
a dental substance applicator, said applicator being installable at said orifice, said applicator including
a body,
a projector having a proximal and a distal end, said projector proximal end being adjacent said body,
a bore in said projector for permitting a dental substance to move within it,
an exit orifice located at said projector distal end serving to permit a dental substance to exit said bore,
an applicator tip located at said projector distal end, and adjacent said exit orifice,
a plurality of flexible arms located on said applicator tip, said applicator tip and flexible arms being configured to be useful in applying a dental substance to a dental surface;
permitting a dental substance to move from said reservoir, through said orifice, into said dental substance applicator, through said bore, and out said exit orifice adjacent said applicator tip, and
using said flexible arms to apply said dental substance to a dental surface.

36. A method as recited in claim 35 further comprising using a smoothing bulb from which said flexible arms emanate, said smoothing bulb being useful in applying said dental substance to a dental surface.

37. A method as recited in claim 35 wherein said flexible arms are integral and contiguous with said projector and said body.
